(19) United States
(12) Patent Application Publication
(10) Pub. No.: US 2024/0405399 A1
(43) Pub. Date: Dec. 5, 2024

(54) ENERGY STORAGE CELL

(71) Applicant: TOYOTA JIDOSHA KABUSHIKI KAISHA, Toyota-shi (JP)

(72) Inventors: Kazuhito KATO, Toyota-shi (JP); Junta TAKASU, Nagoya-shi (JP); Atsushi YAMANAKA, Nagoya-shi (JP); Masato ONO, Nagoya-shi (JP); Satoshi MORIYAMA, Nagoya-shi (JP); Kosuke ZUZUKI, Toyota-shi (JP); Kazuki SUGIE, Miyoshi-shi (JP); Kazuya KUMAZAWA, Nagoya-shi (JP)

(73) Assignee: TOYOTA JIDOSHA KABUSHIKI KAISHA, Toyota-shi (JP)

(21) Appl. No.: 18/581,751

(22) Filed: Feb. 20, 2024

(30) Foreign Application Priority Data
May 31, 2023 (JP) 2023-089746

(51) Int. Cl. H01M 50/70; H01M 4/04; H01M 10/0587

(52) U.S. Cl. CPC H01M 50/70; H01M 4/0404; H01M 10/0587

(57) ABSTRACT

An energy storage cell includes a wound electrode assembly including a positive electrode plate (first electrode), a negative electrode plate (second electrode), and a separator. The positive electrode plate includes a plurality of portions (metal pieces) provided at end portions in the Z direction (axial direction). A through hole (opening) is formed in each of the plurality of portions.

### CROSS-REFERENCE TO RELATED APPLICATION

This application claims priority to Japanese Patent Application No. 2023-089746 filed on May 31, 2023, incorporated herein by reference in its entirety.

### BACKGROUND

### 1. Technical Field

The present disclosure relates to energy storage cells.

### 2. Description of Related Art

US Unexamined Patent Application Publication No. 2020/0144676 discloses a cell composed of a first substrate, a separator, and a second substrate that are rolled about a central axis. The first substrate has a tabless structure with no conductive tab. A plurality of metal pieces as conductive portions is provided at an axial end of the first substrate.

### SUMMARY

In the cell of US Unexamined Patent Application Publication No. 2020/0144676, the metal pieces are provided at the axial end of the first substrate, as described above. The metal pieces are provided so as to cover an axial end of the cell. Therefore, the flow of an electrolyte solution is hindered by the metal pieces, and it is sometimes difficult to allow the electrolyte solution to permeate the separator.

The present disclosure was made to solve the above problem, and it is an object of the present disclosure to provide an energy storage cell that can reduce the possibility that penetration of an electrolyte solution into a separator may be hindered by metal pieces when a plurality of metal pieces is provided at an axial end of a wound electrode assembly.

An energy storage cell according to a first aspect of the present disclosure includes:
a wound electrode assembly including a first electrode, a second electrode, and a separator disposed between the first electrode and the second electrode; and
a case that houses the wound electrode assembly.
   The wound electrode assembly is configured in such a manner that the first electrode, the second electrode, and the separator are wound about a winding axis,
   Either or both of the first electrode and the second electrode includes a plurality of metal pieces provided at an end of the wound electrode assembly in an axial direction in which the winding axis extends.
   At least one of the metal pieces has at least one opening.
   The opening includes both a hole and a cut.

In the energy storage cell according to the first aspect of the present disclosure, as described above, at least one of the metal pieces has at least one opening. This configuration allows an electrolyte solution to flow to the separator side through the opening. As a result, it is possible to reduce the possibility that penetration of the electrolyte solution into the separator may be hindered by the metal pieces.

In the energy storage cell according to the first aspect,
the at least one opening may include a plurality of openings.
   This configuration allows the electrolyte solution to flow to the separator side through the openings. As a result, it is possible to further reduce the possibility that penetration of the electrolyte solution into the separator may be hindered by the metal pieces.

In the energy storage cell according to the first aspect,
the at least one opening may be provided in each of the metal pieces.
   This configuration allows the electrolyte solution to flow to the separator side through the openings in each of the metal pieces. As a result, it is possible to further reduce the possibility that penetration of the electrolyte solution into the separator may be hindered compared to the case where the opening is provided in part of the metal pieces.

In the energy storage cell according to the first aspect,
each of the metal pieces may include an axis intersecting portion extending so as to intersect the axial direction, and
the at least one opening may be provided in the axis intersecting portion.
   With this configuration, since the axis intersecting portion is provided so as to intersect the axial direction, the electrolyte solution flowing from one side in the axial direction of the wound electrode assembly can easily flow through the opening.

In the energy storage cell according to the first aspect,
the first electrode may include a first current collector, and a first electrode material layer coating part of the first current collector and facing the separator in a radial direction of the wound electrode assembly,
the first current collector may include a first coated portion coated with the first electrode material layer, and a first uncoated portion located in the end at a position closer to one side in the axial direction than the first coated portion and not coated with the first electrode material layer, and
the first uncoated portion may include the metal pieces.
   This configuration allows the electrolyte solution to flow through the opening that is provided in the first uncoated portion not coated with the first electrode material layer. It is therefore possible to reduce delamination of the first electrode material layer due to the flow of the electrolyte solution.

In the energy storage cell according to the first aspect,
the second electrode may include a second current collector, and a second electrode material layer coating part of the second current collector and facing the separator in a radial direction of the wound electrode assembly,
the second current collector may include a second coated portion coated with the second electrode material layer, and a second uncoated portion located in the end at a position closer to the other side in the axial direction than the second coated portion and not coated with the second electrode material layer, and
the second uncoated portion may include the metal pieces.
   This configuration allows the electrolyte solution to flow through the opening that is provided in the second uncoated portion not coated with the second electrode material layer. It is therefore possible to reduce delamination of the second electrode material layer due to the flow of the electrolyte solution.

In the energy storage cell according to the first aspect,
the at least one opening may include either or both of a through hole and a cut.
   This configuration facilitates the flow of the electrolyte solution through the through hole and the cut.

An energy storage cell according to a second aspect of the present disclosure includes:
a wound electrode assembly including a first electrode, a second electrode, and a separator disposed between the first electrode and the second electrode; and
a case that houses the wound electrode assembly.
   The wound electrode assembly is configured in such a manner that the first electrode, the second electrode, and the separator are wound about a winding axis.
   Either or both of the first electrode and the second electrode includes a plurality of metal pieces provided at an end of the wound electrode assembly in an axial direction in which the winding axis extends.
   Each of the metal pieces includes a radial portion extending in a predetermined direction along a radial direction of the wound electrode assembly.
   The radial portion of part of the metal pieces has a smaller length in the predetermined direction than the radial portion of the remainder of the metal pieces.

In the energy storage cell according to the second aspect of the present disclosure, as described above, the radial portion of part of the metal pieces has a smaller length in the predetermined direction than the radial portion of the remainder of the metal pieces. Since the radial portion of part of the metal pieces is relatively short, clearance can be provided between the metal pieces. This configuration allows the electrolyte solution to flow to the separator side through the clearance. As a result, it is possible to reduce the possibility that penetration of the electrolyte solution into the separator may be hindered by the metal pieces.

According to the present disclosure, when a plurality of metal pieces is provided at an end in an axial direction of a wound electrode assembly, it is possible to reduce the possibility of penetration of an electrolyte solution into a separator by the metal pieces.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a cross-sectional view illustrating a configuration of an energy storage cell according to a first embodiment;

FIG. 2 is a schematic perspective view showing a configuration of a wound electrode assembly according to the first embodiment;

FIG. 3 is a partially enlarged view of the positive electrode side of FIG. 1;

FIG. 4 is a partially enlarged view of the negative electrode side of FIG. 1;

FIG. 5 is a plan view illustrating a configuration of a positive electrode plate according to the first embodiment;

FIG. 6 is a plan view illustrating a configuration of a negative electrode plate according to the first embodiment;

FIG. 7 is a partially enlarged view of the vicinity of the positive electrode uncoated portion of FIG. 5;

FIG. 8 is a cross-sectional view showing a configuration of a positive electrode side of the wound electrode assembly according to the second embodiment;

FIG. 9 is a cross-sectional view showing a configuration of a negative electrode side of the wound electrode assembly according to the second embodiment;

FIG. 10 is a partially enlarged view of the vicinity of the positive electrode uncoated portion according to a modification of the first embodiment; and

FIG. 11 is a plan view illustrating a configuration of a positive electrode plate according to a modification of the first embodiment.

### DETAILED DESCRIPTION OF EMBODIMENTS

Hereinafter, embodiments of the present disclosure will be described in detail with reference to the drawings. In the drawings, the same or corresponding parts are denoted by the same reference numerals, and the description thereof will not be repeated.

### First Embodiment

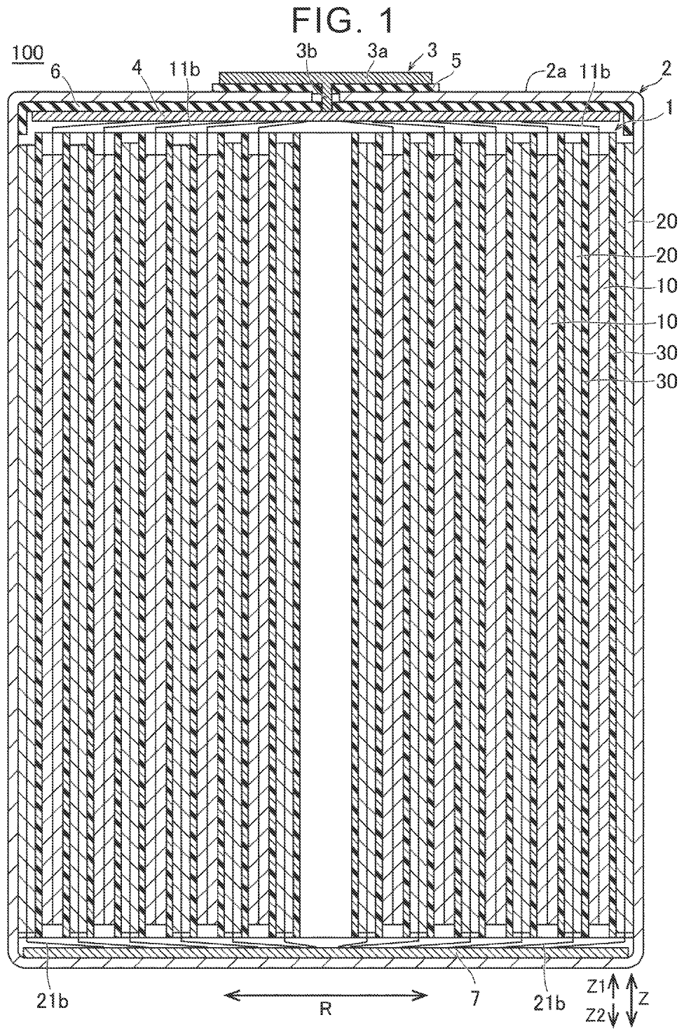

FIG. 1 is a cross-sectional view illustrating an overall configuration of an energy storage cell 100 according to an embodiment of the present disclosure. The energy storage cell 100 is, for example, a lithium-ion battery mounted on a vehicle. Note that the use and type of the energy storage cell 100 are not limited to the above example.

The energy storage cell 100 includes a wound electrode assembly 1, a case 2, a positive electrode terminal 3, a positive electrode current collector plate 4, an external gasket 5, an inner gasket 6, and a negative electrode current collector plate 7.

The wound electrode assembly 1 is accommodated in the case 2. The case 2 has a cylindrical shape. That is, the energy storage cell 100 is a cylindrical battery. The case 2 is made of copper or aluminum.

The wound electrode assembly 1 includes a positive electrode plate 10, a negative electrode plate 20, and a separator 30. The separator 30 is provided between the positive electrode plate 10 and the negative electrode plate 20. The separator 30 separates the positive electrode plate 10 from the negative electrode plate 20 while allowing ions (for example, lithium ions) to move back and forth between the positive electrode plate 10 (positive electrode active material) and the negative electrode plate 20 (negative electrode active material). The wound electrode assembly 1 is constituted by an electrode plate group in which a positive electrode plate 10 and a negative electrode plate 20 are wound with a separator 30 interposed therebetween. The positive electrode plate 10 and the negative electrode plate 20 are examples of the “first electrode” and the “second electrode” of the present disclosure, respectively.

As shown in FIG. 2, the wound electrode assembly 1 is wound such that the positive electrode plate 10, the negative electrode plate 20, and the separator 30 surround the winding axis α. In FIG. 2, a state in which the winding of the wound electrode assembly 1 is slightly unwound is illustrated so that the winding state of the wound electrode assembly 1 can be easily understood.

Referring back to FIG. 1, the positive electrode terminal 3 includes a disc portion 3a and a rivet portion 3b. The rivet portion 3b is connected to the disc portion 3a. The rivet portion 3b is provided so as to extend Z2 from the center of the disc portion 3a. The positive electrode terminal 3 is made of aluminum.

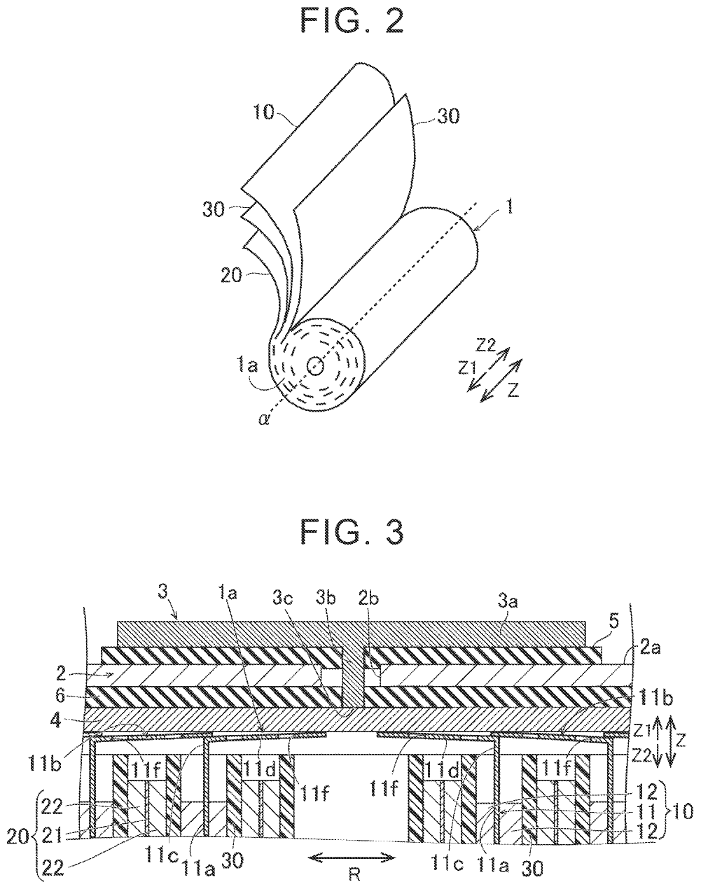

As shown in FIG. 3, the disc portion 3a is disposed on the upper surface 2a (Z1 of the case 2). A through-hole 2b is provided on the upper surface 2a of the case 2. The rivet portion 3b extends from the disc portion 3a disposed outside the case 2 to the inside of the case 2 through the through-hole 2b.

The positive electrode current collector plate 4 is accommodated in the case 2. The positive electrode current collector plate 4 is welded to a later-described positive electrode uncoated portion 11b of the positive electrode plate 10 on Z1 of the wound electrode assembly 1. As a result, the positive electrode current collector plate 4 is positively charged. The positive electrode current collector plate 4 is welded to Z2 end portion 3c of the rivet portion 3b. Thus, the positive electrode terminal 3 is positively charged.

The external gasket 5 is disposed between the disc portion 3a of the positive electrode terminal 3 and the upper surface 2a of the case 2. Thus, the positive electrode terminal 3 and the case 2 are insulated from each other.

The inner gasket 6 is disposed between the case 2 and the positive electrode current collector plate 4 inside the case 2. Thus, the case 2 and the positive electrode current collector plate 4 are insulated from each other. The rivet portion 3b contacts the positive electrode current collector plate 4 by passing through the inner gasket 6.

The positive electrode plate 10 includes a positive electrode current

collector 11 and a positive electrode mixture layer 12. The positive electrode mixture layers 12 are coated on both surfaces in the radial direction (R direction) of the positive electrode current collector 11 (a positive electrode coated portion 11a described later). The positive electrode mixture layer 12 faces the separator 30 in the R direction. The positive electrode current collector 11 and the positive electrode mixture layer 12 are examples of the “first current collector” and the “first electrode material layer”, respectively.

For example, aluminum or the like is used for the positive electrode current collector 11. The positive electrode mixture layer 12 is formed by coating a positive electrode slurry on the surface of the positive electrode current collector 11 and drying the slurry. The positive electrode slurry is a slurry prepared by kneading a material (a positive electrode active material, a binder, or the like) of the positive electrode mixture layer 12 and a solvent. The positive electrode mixture layer 12 is in close contact with the separator 30. The thickness of the positive electrode mixture layer 12 is, for example, 0.1 μm or more and 1000 μm or less.

The positive electrode current collector 11 includes a positive electrode coated portion 11a and a positive electrode uncoated portion 11b. The positive electrode coated portion 11a is a portion of the positive electrode current collector 11 on which the positive electrode mixture layers 12 are coated. The positive electrode coated portion 11a is sandwiched between the separators 30. The positive electrode coated portion 11a is an exemplary “first coated portion” disclosed herein. The positive electrode uncoated portion 11b is one example of the “first uncoated portion” disclosed herein.

The positive electrode uncoated portion 11b is a portion of the positive electrode current collector 11 on which the positive electrode mixture layers 12 are not coated. The positive electrode uncoated portion 11b is located Z1 the positive electrode coated portion 11a. Specifically, the positive electrode uncoated portion 11b protrudes Z1 from the positive electrode coated portion 11a. The positive electrode uncoated portion 11b (portion 11d described later) is provided on Z1 end portion 1a of the wound electrode assembly 1. Note that Z1 side is an exemplary “one axial side” of the present disclosure.

The positive electrode uncoated portion 11b includes a portion 11c extending along the Z direction and a portion 11d extending along the R direction. The positive electrode uncoated portion 11b is bent radially inward. The positive electrode uncoated portion 11b is bent in an L-shape. The portion 11d of the positive electrode uncoated portion 11b contacts the positive electrode current collector plate 4. As a result, the positive electrode current collector plate 4 is positively charged. The positive electrode uncoated portion 11b (portion 11d) is welded to the positive electrode current collector plate 4. In addition, the portion 11d is an exemplary “metallic piece” and “axis intersecting portion” of the present disclosure.

A plurality of portion 11d of the positive electrode uncoated portion 11b are arranged side by side along the winding direction of the wound electrode assembly 1. A slit 11e (see FIG. 5) is provided between the portions 11d adjacent to each other in the winding direction. The portions 11d adjacent to each other in the R direction (radial direction) are provided so as to partially overlap each other. The portions 11c of the positive electrode uncoated portion 11b is provided so as to extend in the winding direction. That is, each of the plurality of portions 11d is connected to one portion 11c.

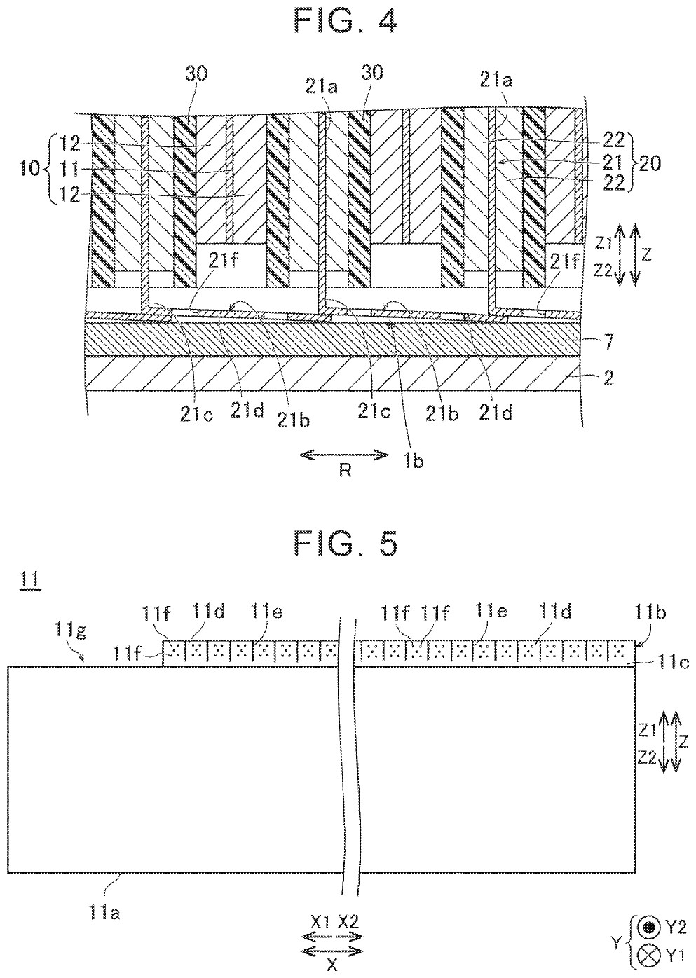

As shown in FIG. 4, the negative electrode current collector plate 7 is accommodated in the case 2. The negative electrode current collector plate 7 is welded to a negative electrode uncoated portion 21b, which will be described later, of the negative electrode plate 20 on Z2 of the wound electrode assembly 1. As a result, the negative electrode current collector plate 7 is negatively charged. The negative electrode current collector plate 7 is in contact with the case 2. Thus, the case 2 is negatively charged.

The negative electrode plate 20 includes a negative electrode current collector 21 and a negative electrode mixture layer 22. The negative electrode mixture layers 22 are coated on both surfaces in the radial direction (R direction) of the negative electrode current collector 21 (a negative electrode coated portion 21a described later). The negative electrode mixture layer 22 faces the separator 30 in the R direction. The negative electrode current collector 21 and the negative electrode mixture layer 22 are examples of the “second current collector” and the “second electrode material layer” of the present disclosure, respectively.

For example, copper or the like is used for the negative electrode current collector 21. The negative electrode mixture layer 22 is formed by coating a negative electrode slurry on the surface of the negative electrode current collector 21 and drying the negative electrode slurry. The negative electrode slurry is a slurry prepared by kneading a material (a negative electrode active material, a binder, or the like) of the negative electrode mixture layer 22 and a solvent. The negative electrode mixture layer 22 is in close contact with the separator 30. The thickness of the negative electrode mixture layer 22 is, for example, 0.1 μm or more and 1000 μm or less.

The negative electrode current collector 21 includes a negative electrode coated portion 21a and a negative electrode uncoated portion 21b. The negative electrode coated portion 21a is a portion of the negative electrode current collector 21 on which the negative electrode mixture layers 22 are coated. The negative electrode coated portion 21a is sandwiched between the separators 30. The negative electrode coated portion 21a is an exemplary “second coated portion” of the present disclosure. The negative electrode uncoated portion 21b is an exemplary “second uncoated portion” disclosed herein.

The negative electrode uncoated portion 21b is a portion of the negative electrode current collector 21 on which the negative electrode mixture layers 22 are not coated. The negative electrode uncoated portion 21b is located Z2 the negative electrode coated portion 21a. Specifically, the negative electrode uncoated portion 21b protrudes Z2 from the negative electrode coated portion 21a. The negative electrode uncoated portion 21b is provided on Z2 end 1b of the wound electrode assembly 1. Note that Z2 side is an exemplary “other axial side” of the present disclosure.

The negative electrode uncoated portion 21b includes a portion 21c extending along the Z direction and a portion 21d extending along the R direction. The negative electrode uncoated portion 21b is bent radially inward. The negative electrode uncoated portion 21b is bent in an L-shape. The portion 21d of the negative electrode uncoated portion 21b contacts the negative electrode current collector plate 7. As a result, the negative electrode current collector plate 7 is negatively charged. The negative electrode uncoated portion 21b (portion 21d) is welded to the negative electrode current collector plate 7. In addition, the portion 21d is an exemplary “metallic piece” and “axis intersecting portion” of the present disclosure.

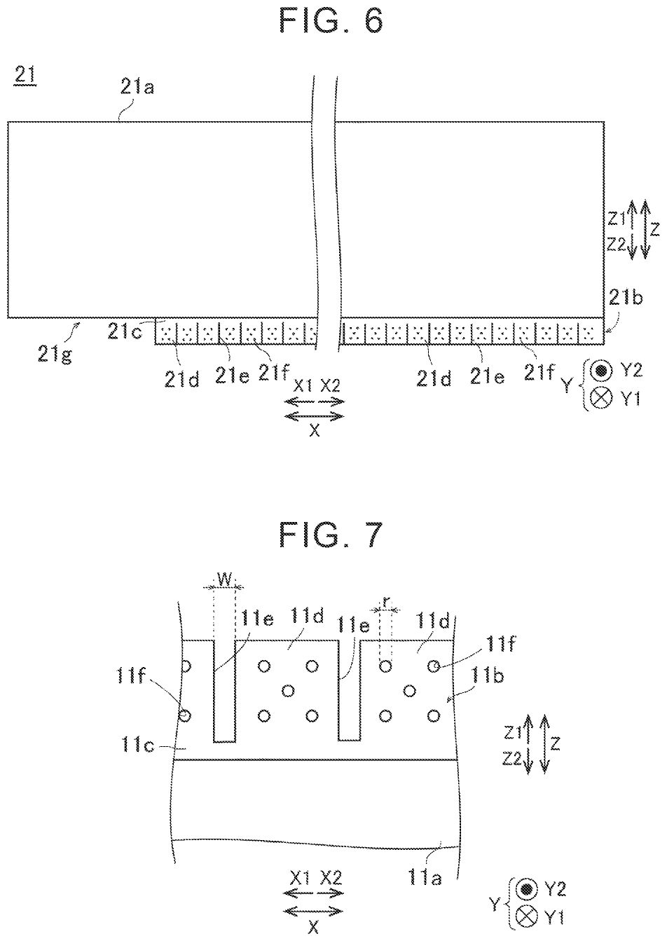

A plurality of portions 21d of the negative electrode uncoated portion 21b are arranged side by side along the winding direction of the wound electrode assembly 1. A slit 21c (see FIG. 6) is provided between the portions 21d adjacent to each other in the winding direction. The portions 11d adjacent to each other in the R-direction are provided so as to partially overlap each other. The portion 21c of the negative electrode uncoated portion 21b is provided so as to extend in the winding direction. That is, each of the plurality of portions 21d is connected to one portion 21c.

Here, in the conventional configuration of the energy storage cell, the uncoated portion is provided so as to cover the axial end portion of the wound electrode assembly. Therefore, the flow of the electrolyte solution is hindered by the uncoated portion, and it may be difficult to allow the electrolyte solution to permeate into the separator.

Therefore, in the first embodiment, as shown in FIG. 3, a through hole 11f is formed in each of the plurality of portions 11d. Since the plurality of portions 11d extend so as to intersect (substantially perpendicular to) the axial direction (Z direction), the axial direction is the penetrating direction in the through hole 11f. Note that the through hole 11f is an example of the “opening” of the present disclosure.

Each of the plurality of portions 11d is provided with a plurality of through holes 11f. At least part of the plurality of through holes 11f is provided at a position overlapping with the separators 30 in the Z-direction. As a result, the electrolyte solution flowing through the through hole 11f can be efficiently circulated to the separators 30. Note that the position of the through hole 11f is not limited to the above embodiment.

As shown in FIG. 4, a through hole 21f is formed in each of the plurality of portions 21d. Since the plurality of portions 21d extend so as to intersect (substantially perpendicular to) the axial direction (Z direction), the axial direction is the penetrating direction in the through hole 21f. Note that the through hole 21f is an exemplary “opening” of the present disclosure.

Each of the plurality of portions 21d is provided with a plurality of through holes 21f. At least a part of the plurality of through holes 21f is provided at a position overlapping with the separators 30 in the Z-direction. As a result, the electrolyte solution flowing through the through hole 21f can be efficiently circulated to the separators 30.

FIG. 5 is a plan view of the positive electrode current collector 11 in a state of being unwound. As shown in FIG. 5, five through holes 11f are formed in each of the plurality of portions 11d. Note that the positive electrode uncoated portion 11b is not formed on the inner portion 11g of the winding (for example, a portion corresponding to the winding of the innermost circumference) of the positive electrode current collector 11, and is provided on the outer peripheral side of the inner portion 11g. Note that the X direction shown in FIGS. 5 to 7 to corresponds to the winding direction of the wound electrode assembly 1.

FIG. 6 is a plan view of the negative electrode current collector 21 in a state of being unwound. As shown in FIG. 6, five through holes 21f are formed in each of the plurality of portions 21d. Note that the negative electrode uncoated portion 21b is not formed on the inner portion 21g of the winding (for example, a portion corresponding to the winding of the innermost circumference) of the negative electrode current collector 21, and is provided on the outer peripheral side of the inner portion 21g.

FIG. 7 is a partially enlarged view of FIG. 5. As shown in FIG. 7, each of the plurality of through holes 11f has a circular shape. Specifically, the plurality of through holes 11f have a true circular shape having a diameter r. The configuration of the through hole 11f is not limited to the above-described configuration. Further, since the through hole 21f has the same configuration as the through hole 11f, illustration thereof is omitted.

In addition, the slit 11e has a width W in the X direction. The diameter r of the through hole 11f is smaller than the width W of the slit 11e. Note that the diameter r may be equal to or larger than the width W. Further, although detailed drawings are omitted, the through hole 21f and the slit 21e have the same size (shapes) as the through hole 11f and the slit 11e, respectively.

As described above, in the first embodiment, the through hole 11f is formed in each of the plurality of portions 11d of the positive electrode uncoated portion 11b. Thus, even if the separator 30 is covered with the positive electrode uncoated portion 11b, the electrolyte solution can be introduced into the separator 30 through the through hole 11f. As a result, even if an excess of the electrolyte solution is squeezed out due to expansion during charging and discharging of the wound electrode assembly 1, the electrolyte solution can be quickly returned to the wound electrode assembly 1. In addition, it is possible to reduce a decrease in resistance of the wound electrode assembly 1 from deteriorating due to insufficient electrolyte solution in the wound electrode assembly 1.

### Second Embodiment

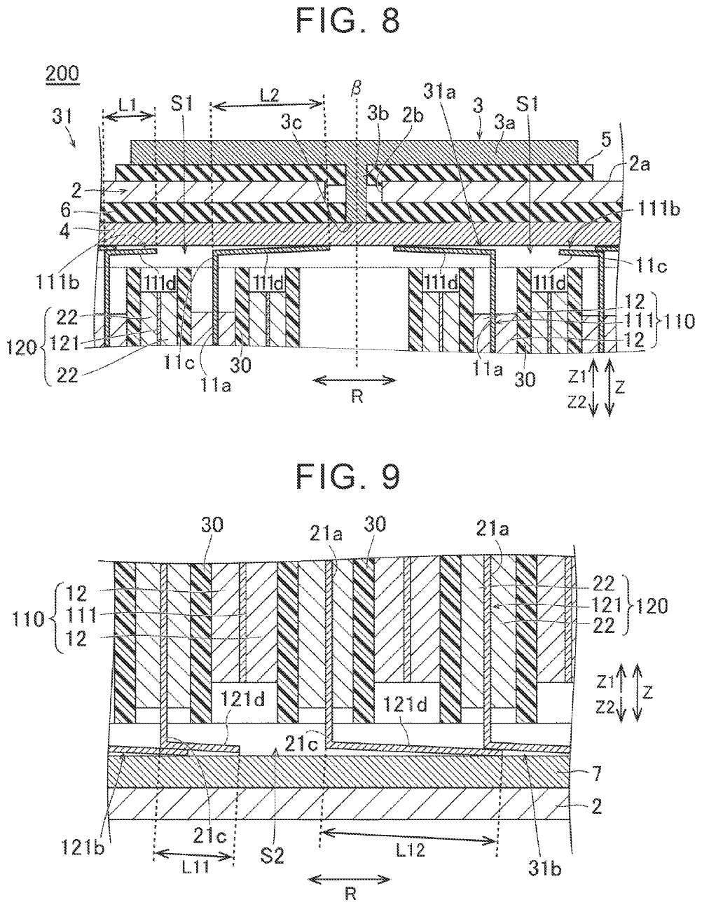

A second embodiment of the present disclosure will be described with reference to FIGS. 8 and 9. In the second embodiment, unlike the first embodiment in which through holes are formed in each of the positive electrode uncoated portion 11b and the negative electrode uncoated portion 21b, no through holes are formed in each of the positive electrode uncoated portion and the negative electrode uncoated portion. The same components as those in the first embodiment are denoted by the same reference numerals and will not be described repeatedly.

As shown in FIG. 8, the energy storage cell 200 is different from the energy storage cell 100 of the first embodiment in that a wound electrode assembly 31 is provided instead of the wound electrode assembly 1. The wound electrode assembly 31 is accommodated in the case 2.

The wound electrode assembly 31 includes a positive electrode plate 110, a negative electrode plate 120, and a separator 30. The separator 30 is provided between the positive electrode plate 110 and the negative electrode plate 120. The positive electrode plate 110 and the negative electrode plate 120 are examples of the “first electrode” and the “second electrode” of the present disclosure, respectively.

The wound electrode assembly 31 is wound such that the positive electrode plate 110, the negative electrode plate 120, and the separator 30 surround the winding axis β.

The positive electrode plate 110 includes a positive electrode current collector 111 and a positive electrode mixture layer 12. The positive electrode current collector 111 includes a positive electrode coated portion 11a and a positive electrode uncoated portion 111b. The positive electrode uncoated portion 111b (portion 111d described later) is provided on Z1 end portion 31a of the wound electrode assembly 31.

The positive electrode uncoated portion 111b includes a portion 11c extending along the Z direction and a portion 111d extending along the R direction. The positive electrode uncoated portion 111b is bent radially inward. The positive electrode uncoated portion 111b is bent in an L-shape. Note that the portion 111d is an exemplary “metallic piece” and “radial portion” of the present disclosure.

A plurality of portions 111d of the positive electrode uncoated portion 111b are arranged side by side along the winding direction of the wound electrode assembly 31. That is, each of the plurality of portions 111d is connected to one portion 11c extending in the winding direction.

In the second embodiment, a portion of the plurality of portions 111d has a smaller length in a direction along the radial direction (a direction in which the portions 111d extends in FIG. 8) than a remaining portion of the plurality of portion 111d. The length L1 of the portion 111d of the part is smaller than the length L2 of the portion 111d of the remaining part. As a result, clearance S1 is formed between the portion 111d in the length L1 and the portion 111d in the length L2, which are arranged side by side in the radial direction. The clearance S1 (opening) may be formed at a position overlapping the separators 30 in the axial direction (Z direction). In FIG. 8, the direction in which the portion 111d extends is an exemplary “predetermined direction” of the present disclosure.

Note that the positional relation between the portion 111d in the length L1 and the portion 111d in the length L2 is not limited to that shown in FIG. 8. For example, the portion 111d in the length L1 may be disposed at a position closest to the winding axis β among the plurality of portions 111d.

As illustrated in FIG. 9, the negative electrode plate 120 includes a negative electrode current collector 121 and a negative electrode mixture layer 22. The negative electrode current collector 121 includes a negative electrode coated portion 21a and a negative electrode uncoated portion 121b. The negative electrode uncoated portion 121b (portion 121d described later) is provided on Z2 end portion 31b of the wound electrode assembly 31.

The negative electrode uncoated portion 121b includes a portion 21c extending along the Z direction and a portion 121d extending along the R direction. The negative electrode uncoated portion 121b is bent radially inward. The negative electrode uncoated portion 121b is bent in an L-shape. Note that the portion 121d is an exemplary “metallic piece” and “radial portion” of the present disclosure.

A plurality of portions 121d of the negative electrode uncoated portion 121b are arranged side by side along the winding direction. That is, each of the plurality of portions 121d is connected to one portion 21c extending in the winding direction.

In the second embodiment, part of the plurality of portions 121d has a smaller length in a direction along the radial direction (a direction in which the portions 121d extend in FIG. 9) than the remainder of the plurality of portions 121d. The length L11 of the portion 121d of the part is smaller than the length L12 of the part 121d of the remaining part. As a result, clearance S2 (opening) is formed between the portion 121d in the length L11 and the portion 121d in the length L12, which are arranged side by side in the radial direction. The clearance S2 may be formed at a position overlapping the separators 30 in the axial direction (Z direction). Note that the direction in which the portion 121d extends in FIG. 9 is an exemplary “predetermined direction” of the present disclosure.

Note that the positional relation between the portion 121d in the length L11 and the portion 121d in the length L12 is not limited to that shown in FIG. 9. For example, the portion 121d in the length L11 may be disposed at a position closest to the winding axis β among the plurality of portions 121d.

As described above, in the second embodiment, a portion of the plurality of portions 111d (121d) has a smaller length in the direction in which the portion 111d (121d) extends than a remaining portion of the plurality of portions 111d (121d). As a result, clearance S1 (S2) is formed between the portions 111d (121d) when the portions 111d (121d) are radially arranged next to each other. This allows the electrolyte solution to flow through the clearance S1 (S2) toward the separators 30.

In the first embodiment, a plurality of through holes 11f (21f) are provided in the portion 11d (21d), but the present disclosure is not limited thereto. The portion 11d (21d) may be provided with only one through hole 11f (21f).

In the first embodiment, the through hole 11f (21f) is provided in each of the plurality of portions 11d (21d), but the present disclosure is not limited thereto. A through hole 11f (21f) may be provided in a part of the plurality of portions 11d (21d). For example, the through holes 11f (21f) may be provided only in one portion 11d (21d).

In the first embodiment, the through hole 11f (21f) is provided in the portion 11d (21d), but the present disclosure is not limited thereto. A through hole may be provided in the portion 11c (21c). In addition, through holes may be provided in each of the portions 11d (21d) and 11c (21c).

In the first embodiment, the through hole 11f (21f) is provided in the portion 11d (21d), but the present disclosure is not limited thereto. An opening other than the through hole may be provided. In the embodiment shown in FIG. 10, the portion 211d is provided with a cutout 211a. The cutout 211a is provided at an end portion 211b (radially inner end portion) of the portion 211d. The cutout 211a are arranged side by side in the winding direction (X direction in FIG. 10), i.e., two in FIG. 10. The same may be applied to the negative electrode side. In addition, both the through hole and the cut may be formed. Note that the portion 211d is an exemplary “axial portion” and “metallic piece” of the present disclosure. Further, the cutout 211a is an exemplary “opening” of the present disclosure.

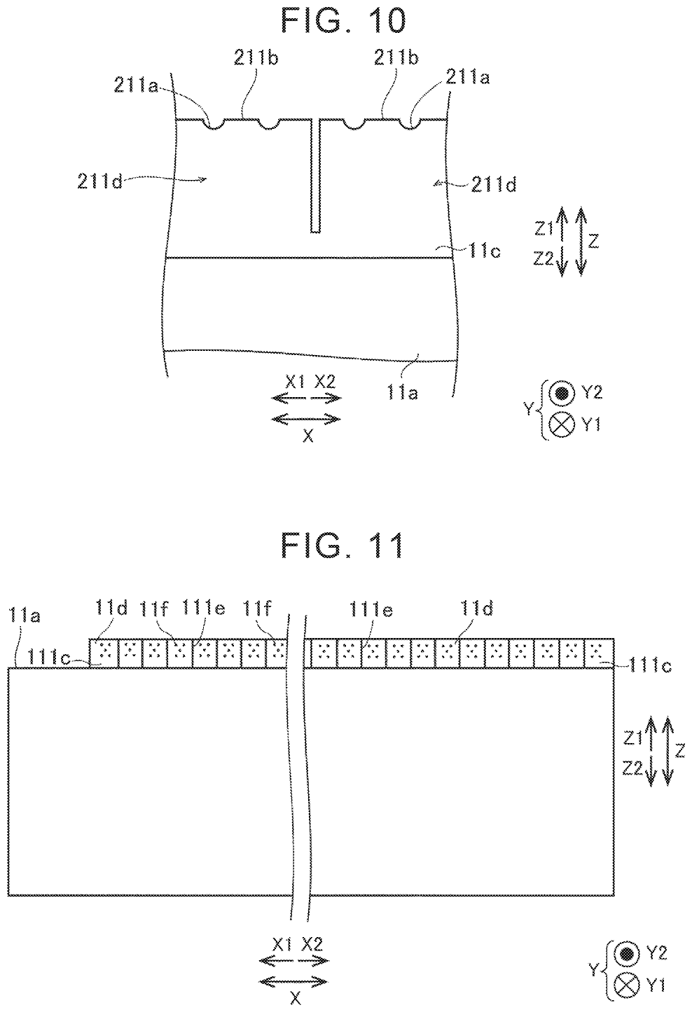

In the first embodiment, a plurality of portions 11d are connected to a single axially extending portion 11c, but the present disclosure is not limited thereto. As shown in FIG. 11, an axially extending portion 111c (a portion corresponding to the portion 11c) may be connected to each of the plurality of portion 11d. In the embodiment shown in FIG. 11, a slit 111e is formed between a plurality of metallic pieces formed by the portion 11c and the portion 11d. The negative electrode side may be similarly configured.

In the first embodiment, the through holes are formed in each of the positive electrode uncoated portion 11b and the negative electrode uncoated portion 21b, but the present disclosure is not limited thereto. A through hole may be formed in only one of the positive electrode uncoated portion 11b and the negative electrode uncoated portion 21b.

In the second embodiment, a part of the length is smaller than the remaining part of the length in both of the plurality of portions 111d on the positive electrode side and the plurality of portions 121d on the negative electrode side. In only one of the plurality of portions 111d on the positive electrode side and the plurality of portions 121d on the negative electrode side, a length of a portion may be smaller than a length of a remaining portion.

In the first (second) embodiment, the positive electrode uncoated portion 11b (111b) and the negative electrode uncoated portion 21b (121b) are bent radially inward, but the present disclosure is not limited thereto. At least one of the positive electrode uncoated portion 11b (111b) and the negative electrode uncoated portion 21b (121b) may be bent radially outward.

Note that the configurations of the above-described embodiment and the above-described modification examples may be combined with each other.

The embodiments disclosed herein are to be considered in all respects as illustrative and not restrictive. It is intended that the scope of the disclosure be defined by the appended claims rather than the description of the embodiments described above, and that all changes within the meaning and range of equivalency of the claims be embraced therein.

What is claimed is:

1. An energy storage cell, comprising:
a wound electrode assembly including a first electrode, a second electrode, and a separator disposed between the first electrode and the second electrode;
a case that houses the wound electrode assembly, wherein
the wound electrode assembly is configured in such a manner that the first electrode, the second electrode, and the separator are wound about a winding axis,
either or both of the first electrode and the second electrode includes a plurality of metal pieces provided at an end of the wound electrode assembly in an axial direction in which the winding axis extends, and
at least one of the metal pieces has at least one opening.

2. The energy storage cell according to claim 1, wherein the at least one opening includes a plurality of openings.

3. The energy storage cell according to claim 1, wherein the at least one opening is provided in each of the metal pieces.

4. The energy storage cell according to claim 1, wherein
each of the metal pieces includes an axis intersecting portion extending so as to intersect the axial direction, and
the at least one opening is provided in the axis intersecting portion.

5. The energy storage cell according to claim 1, wherein
the first electrode includes a first current collector, and a first electrode material layer coating part of the first current collector and facing the separator in a radial direction of the wound electrode assembly,
the first current collector includes a first coated portion coated with the first electrode material layer, and a first uncoated portion located in the end at a position closer to one side in the axial direction than the first coated portion and not coated with the first electrode material layer, and
the first uncoated portion includes the metal pieces.

6. The energy storage cell according to claim 1, wherein
the second electrode includes a second current collector, and a second electrode material layer coating part of the second current collector and facing the separator in a radial direction of the wound electrode assembly,
the second current collector includes a second coated portion coated with the second electrode material layer, and a second uncoated portion located in the end at a position closer to the other side in the axial direction than the second coated portion and not coated with the second electrode material layer, and
the second uncoated portion includes the metal pieces.

7. The energy storage cell according to claim 1, wherein the at least one opening includes either or both of a through hole and a cut.

8. An energy storage cell, comprising:
a wound electrode assembly including a first electrode, a second electrode, and a separator disposed between the first electrode and the second electrode;
a case that houses the wound electrode assembly, wherein
the wound electrode assembly is configured in such a manner that the first electrode, the second electrode, and the separator are wound about a winding axis,
either or both of the first electrode and the second electrode includes a plurality of metal pieces provided at an end of the wound electrode assembly in an axial direction in which the winding axis extends,
each of the metal pieces includes a radial portion extending in a predetermined direction along a radial direction of the wound electrode assembly, and
the radial portion of part of the metal pieces has a smaller length in the predetermined direction than the radial portion of the remainder of the metal pieces.
